(19) United States
(12) Patent Application Publication
(10) Pub. No.: US 2003/0131201 A1
(43) Pub. Date: Jul. 10, 2003

(54) Mechanism for efficiently supporting the full MESI (modified, exclusive, shared, invalid) protocol in a cache coherent multi-node shared memory system

(76) Inventors: Manoj Khare, Saratoga, CA (US); Lily P. Looi, Portland, OR (US); Akhilesh Kumar, Sunnyvale, CA (US); Faye A. Briggs, Portland, OR (US)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 09/752,534

(22) Filed: Dec. 29, 2000

(51) Int. Cl. G06F 12/08

(52) U.S. Cl. 711/144; 711/145; 711/146; 711/119

(57) ABSTRACT

A method and apparatus are described for supporting the full MESI (Modified, Exclusive, Shared or Invalid) protocol in a distributed shared memory environment implementing a snoop based architecture. A requesting node submits a single read request to a snoop based architecture controller switch. The switch recognizes that a responding node other than the requesting node and the home node for the desired data has a copy of the data in an ambiguous state. The switch resolves this ambiguous state by snooping the remote node. After resolving the ambiguous state, the read request transaction is completed.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND OF THE INVENTION

1. Field of the Invention

The invention relates generally to the field of shared memory multiprocessor architectures. More particularly, the invention relates to providing a centralized mechanism, termed a snoop filter, that tracks and resolves ambiguous states at member nodes of the shared memory multiprocessor system in order to accommodate the full Modified, Exclusive, Shared and Invalid (MESI) Protocol as implemented by various architectures.

2. Description of the Related Art

In the area of distributed computing when multiple processing nodes access each other's memory, the necessity for memory coherency is evident. Various methods have evolved to address the difficulties associated with shared memory environments. One such method involves a distributed architecture in which each node of the distributed shared memory environment incorporates a resident coherence manager. Because of the complexity involved in providing support for various protocol implementations of corresponding architectures, existing shared memory multiprocessing architectures fail to support the full range of MESI protocol possibilities. One such method, referred to as a broadcasting method, requires each node of the multi-node shared memory environment to treat each access to a memory by taking a copy of the contents in the Shared state. Any node sharing the data must broadcast any modification to the data to all other nodes sharing the cache line. This broadcasting solution, although workable, provides several limitations to shared memory environments. One problem is that a member node may not gain Exclusive access to the data. By not supporting an Exclusive state, inherent latency and inefficient bus utilization results because a node must always take time to check the bus to make sure another node is not broadcasting a change and is prevented from making any modification to the data until it is clear that the modification by the member node will not result in a conflict. Consequently, the broadcast solution does not support the full MESI protocol, requires each and every node to broadcast each change to its memory even when it is the only node accessing the memory and ultimately requires excessive bus usage creating inherent limitations on the memory access speeds. Additionally, no mechanism is built into the architectures to provide intelligent handling of read requests.

FIGS. 8-9 demonstrate an example of one such broadcast type architecture. The shared memory environment has three nodes 810, 820 and 830 and a shared bus 840 between the nodes. Although each node contains similar elements and functionality necessary to be part of shared memory environment, such as a memory and a local coherence controller (not shown), the nodes have been conveniently labeled as resource node 810, home node 820 and remote node 830 in order to demonstrate an illustrative example of the architecture. In this example, each node that currently has a copy of the contents of a cache line broadcasts any modification to the contents or status of the cache line to the other participating nodes by broadcasting the information onto the bus. At step 910, the responding node broadcasts that it is taking a copy of the contents, in this example “X”, of Memory location 850 from the home node and broadcasts that it is in a shared state ownership. Any other node having a copy of the contents of Memory location 850 that makes changes to the contents must broadcast its changes to any node sharing the line as well as the home node's memory location.

At step 920, the requesting node wishes to obtain a copy of the contents of Memory location 850 so it reads a copy of the contents from the home node. The home node must always have the most recent copy of the contents because any modification to the contents by a node having a copy must always broadcast the changes to the home node. The requesting node, having taken a copy of the memory contents in a shared state, may now alter the contents. Coherence protocols in such a broadcast type system must resolve conflict issues that arise due to contents being modified simultaneously by multiple nodes sharing the contents. For instance, at step 930, both the responding node and the requesting node wish to modify the contents and seek to broadcast the change of the contents across the system bus. Each local node coherence manager seeks access to the bus and informs the processor seeking to modify the contents whether the modification and broadcast can occur. This system provides no mechanism for supporting an exclusive state and consequently requires one of the nodes wishing to access the bus to invalidate their copy of the cache line. For example, if the local coherence manager of the responding node 830 gains access to the bus first for broadcasting its modification to the contents of memory 850, the local coherence manager for the requesting node will see that the contents are being modified when it seeks access to the bus and must instruct the processor wishing to modify its copy to wait until the new copy has been registered as the most recent copy. The requesting node 810 then submits an additional request to get the most recent copy of the contents from the home node 820 and, after checking to see if it is safe to make a modification, makes a new modification to the contents. In addition to creating memory modification problems and potential application halts or errors, bus traffic caused by continued broadcasting of the modifications limits the extensibility of the system architecture because more resources and architectural real estate must be generated to support the increased traffic and increasingly complicated coherence issues created by a broadcasting system that does not support the full MESI protocol.

This broadcast method is incapable of supporting an exclusive state. Rather, it supports only three of the desired states, Modified, Shared and Invalid by requiring any node wishing to modify the contents to obtain a copy in a Shared state. Additionally, each modification must then be broadcast to all nodes Sharing the cache line. By not supporting the Exclusive state and requiring broadcasting of any modification, the resulting coherence resolution and bus usage demand limit the extensibility of the shared memory environment by requiring increased real estate for additional nodes and limits the functionality of the member nodes. Additionally, as every modification must be broadcast to other nodes, any local write on a node must check the bus to make sure the cache has not been modified causing unnecessary latency in internal writes to the cache line.

### BRIEF DESCRIPTION OF THE SEVERAL VIEWS OF THE DRAWINGS

The present invention is illustrated by way of example, and not by way of limitation, in the figures of the accompanying drawings and in which like reference numerals refer to similar elements and in which:

FIG. 1 illustrates a cache coherent multi-node shared memory environment in which one embodiment of the present invention may be implemented.

FIG. 2 demonstrates an example of how a snoop filter tracks ambiguous MESI states and resolves those states according to one embodiment of the present invention.

FIG. 3 is a flow chart demonstrating a read processing in the illustrated environment of FIG. 2.

FIGS. 4 and 5 demonstrate one example of resolving an ambiguous state where the remote node has not modified the data since last accessing the cache line in an Exclusive state.

FIGS. 6 and 7 demonstrate one example of resolving an ambiguous state where the remote node has modified the data after taking the cache line in an Exclusive state.

FIGS. 8-9 illustrate an example of a conventional broadcasting shared memory environment.

### DETAILED DESCRIPTION OF THE INVENTION

A method and apparatus are described for tracking ambiguous states in a multi-node shared memory environment. Additionally, based on the ambiguous states, requests are routed and nodes are probed to resolve any existing ambiguities and correctly route the request to the proper target node.

Enclosed is a mechanism for supporting the full MESI protocol so that multiple architectures can simultaneously be implemented in the same shared memory environment without creating problematic bus demand and unnecessary coherence complications resulting from shared status when an exclusive status is preferable. The enclosed mechanism also supports an Exclusive state so any member node may make multiple modifications and need not report any modifications to the home node or any other node until another node requests access to the cache line.

In the following description, for the purposes of explanation, numerous specific details are set forth in order to provide a thorough understanding of the present invention. However, the present invention may be practiced without some of the specific detail provided therein. The invention is described herein primarily in terms of a requesting node initiating a request to a cache line in a distributed shared memory environment. The cache line is accessible by the requesting node, a home node that maintains permanent storage of the cache line memory and a responding node that may have a copy of the cache that is being targeted by the requesting node. The request is sent to an intermediate switch that tracks, by using a snoop filter, the status of each cache line accessible in the shared memory environment. The switch determines the status of the cache line of interest by looking at a table maintained in the snoop filter. Wherever an ambiguity exists, i.e. the last known state for the cache line at a given node was a state that could have transitioned since last reported, the switch snoops the node to resolve the ambiguity and makes sure the request is properly routed. The invention, however, is not limited to this particular embodiment alone, nor is it limited to use in conjunction with any particular distributed shared memory environment. For example, the claimed method and apparatus may be used in conjunction with various system architectures such as IA32 or IA64 based architectures. It is contemplated that certain embodiments may be utilized wherein a request is received by an intermediate traffic switch, ambiguous states are resolved so as to properly handle the request and the request is properly routed.

The present invention includes various operations that will be described below. The operations of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs, magneto-optical disks, ROMs, RAMs, EPROMs, EEPROMs, magnetic or optical cards, flash memory, or other type of media/machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Terminology

Brief initial definitions of terms used throughout this application are given below to provide a common reference point.

A Home Node is a node where the contents of a cache line are permanently stored.

A Responding Node is a node that has a copy of the contents of the cache line of question and whose cache line state is ambiguous at the time the switch receives a request concerning the cache line.

A Requesting Node is a node that initiates a request concerning contents of a particular cache line or memory.

An ambiguous state is a condition tracked in a snoop filter that identifies the last known state of a cache line at a member node. When the state last identified is one that could have changed at the member node, then the state is determined to be ambiguous.

Exemplary Operating Environment

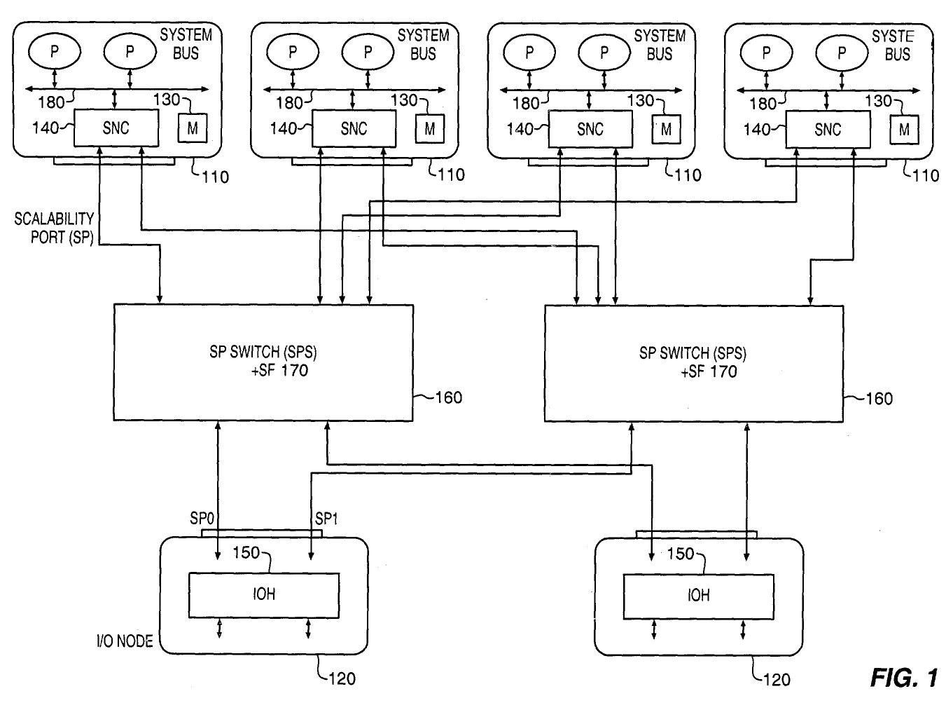

FIG. 1 illustrates an exemplary operating environment 100 according to one embodiment of the invention. In this example, multiple nodes 110 and 120 share memory through a cache based coherence system. The nodes supported are processor nodes 110 each having a local memory 130 and Input/Output (IO) nodes 120. The cache based coherence system is collectively designated the Scalability Port (SP). In node environments with more than two nodes, the SP includes a System Node Controller (SNC) chip 140 in each of the processor nodes 110 and an IO Hub (IOH) 150 chip in each of the IO nodes 120. The IO node implements a cache, such as an L2 cache, so that it may participate in cache coherency. In addition to the SNC 140 and the IOH 150, the SP provides central control for its snoop architecture in a Scalability Port Switch (SPS) 160 that includes a snoop filter (SF) 170 to track the state of cache lines in all the caching nodes. The SNC 140 interfaces with the processor bus 180 and the memory 130 on the processor node 110 and communicates cache line information to the SPS 160 when the line is snooped for its current status. Similarly, the IOH interfaces with the IO Bus and communicates information to the SPS 160 when a line is snooped for its current status.

The SP used to exemplify the invention supports various architectures. For instance, the processor nodes 110 could be based on either the IA32 or IA64 architecture. Unlike prior snoop based cache coherence architectures, the SP supports the full MESI (Modified, Exclusive, Shared and Invalid) protocol as uniquely implemented by both architectures, i.e. the IA32 coherence protocol as well as the IA64 coherence protocol. One example of how these coherence protocols differ is when the cache line state is in a Modified state when a read request is initiated. In the IA32 coherence protocol, once the read request is processed, the state of the cache line transitions from Modified to an Invalid state whereas in the IA64 coherence protocol, the cache line, once read, transitions from a Modified state to a Shared state. The support of multiple architectures allows for scalability and versatility in the future development of architectures and their corresponding protocols by allowing for the resident component of the SP, i.e, the SNC for the processor node and the IOH for the IO Node, to be implemented to handle the new architecture and its corresponding protocol without having to redesign the central snoop controller, the SPS.

The central snoop controller switch performs coherence in order to resolve existing ambiguities occurring in the Snoop Filter. This Central Snoop Coherence protocol is an invalidation protocol where any caching node or agent that intends to modify a cache line acquires an exclusive copy in its cache by invalidating copies at all the other caching agents. The coherence protocol assumes that the caching agents support some variant of the MESI protocol, where the possible states for a cache line are Modified, Exclusive, Shared or Invalid. The transitions between these states on various local and remote operations may be different for different types of caching agents. The coherence protocol provides flexibility in snoop responses such that the controller switch can support different types of state transitions. For example, a cache line in the Modified state can transition to a Shared state on a remote snoop or an Invalid state on a remote snoop, and the snoop response can indicate this for appropriate state transitions at the switch and the requesting agent or source node.

The Snoop Filter in the SPS is organized as a tag cache that keeps information about the state of each cache line and a bit vector indicating the presence of the cache line at the various caching nodes. The bit vector, called the presence vector, has one bit per caching node in the system. If a caching agent at any node has a copy of a cache line, the corresponding bit in the presence vector for the cache line is set. A cache line may be in one of either Invalid, Shared, or Exclusive states in the Snoop Filter. The Snoop Filter only tracks the tag and the cache line state at the indicated node and does not maintain a copy of the cache line. The Snoop Filter at the SPS is inclusive of caches at all the caching agents. In other words, a caching agent cannot have a copy of a cache line that is not present in the Snoop Filter. If a line is evicted from the Snoop Filter, it must be evicted from the caching agents of all the nodes, i.e. marked in the presence vector.

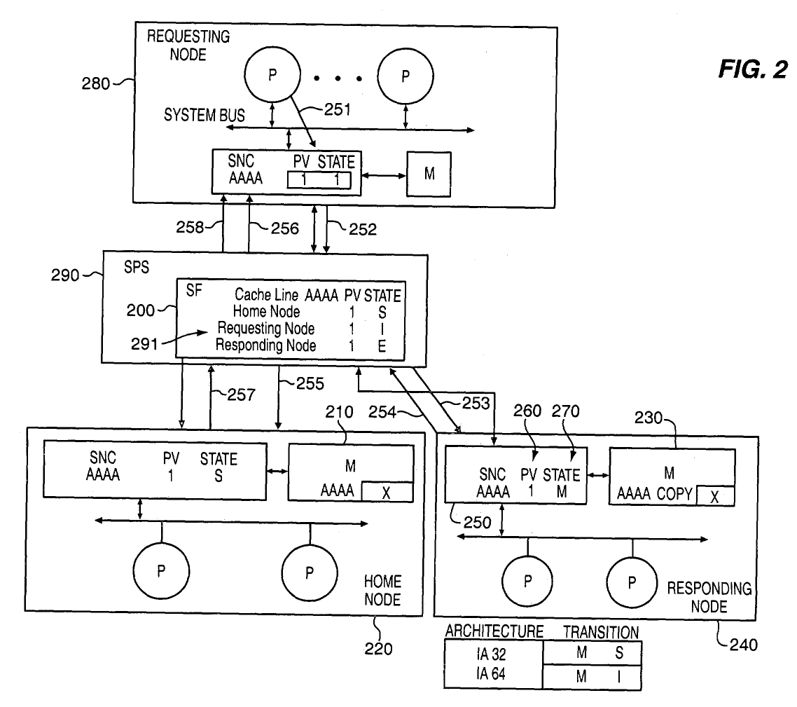

An Illustration of the information maintained in the Snoop Filter 200 is demonstrated abstractly in FIG. 2. The contents of memory location 210, maintained exclusively on the home node 220, are copied and accessible in a cache 230 on the responding node 240. The responding node SNC (or IOH) 250 maintains a local presence vector 260 and status 270 for each cache line it utilizes. A snoop to the SNC of node 240 may result in the Snoop Filter's presence vector and status being updated. If a caching agent at any node has a copy of the cache line, the corresponding bit in the presence vector for that cache line is set. A cache line could be in the Invalid, Shared, or Exclusive state in the Snoop Filter. In this case, the home node's cache line is in a shared state (S), while the resource node 280 is in an invalid state (I) and the remote node's cache line was last known to be in an exclusive state (E). According to the described embodiment, the cache line in the Snoop Filter will not indicate that a line is in a Modified state, because a read to a cache line that has transitioned to a Modified state will result in the Modified line changing states in response to a snoop or read inquiry.

The Snoop Filter is inclusive in that it does not contain the cache data, but only tracks the tag and the state of caches at all the caching agents. It is possible to divide the Snoop Filter into multiple Scalability Port Switches or into multiple caches within one SPS to provide sufficient Snoop Filter throughput and capacity to meet the system scalability requirement. In such cases, different snoop Filters keep track of mutually exclusive sets of cache lines. A cache line is tracked at all times by only one Snoop Filter.

The state of a cache line in the Snoop Filter is not always the same as the state in the caching agent's SNC. Because of the distributed nature of the system, the state transitions at the caching agents and at the Snoop Filter are not always synchronized. In fact, some of the state transitions at the caching agents are not externally visible and therefore it is not possible to update the Snoop Filter with such transactions. For example, transitions from an Exclusive state to a Modified state may not be visible external to the caching agent. Although other ambiguous situations may exist, the usefulness of the invention is illustrated by the scenario described with reference to FIG. 2 where a cache line is in the Exclusive state at the Snoop Filter. In this case, the Snoop Filter is aware only that the caching agent, i.e. the responding or remote node 240, has Exclusive access to the cache line as indicated by the presence vector in the Snoop Filter. However, the state of the cache line at the caching agent may have changed to any of the other MESI protocol states (e.g., Modified, Exclusive, Shared or Invalid). If a request is made to the SPS 290 for a cache line where ambiguity exists (i.e. the state at the node having ownership may have changed), the SPS snoops the cache line, in this case the responding node's cache line, indicated by the presence vector to get its current state and most recent corresponding data if necessitated.

Other Snoop Filter states exist as follows: An Invalid state in the Snoop Filter is unambiguous, the cache line is not valid in any caching agent and all bits in the presence vector for the line in the Snoop Filter must be reset. An unset bit in the presence vector in the Snoop Filter for a cache line is unambiguous, the caching agents at the node indicated by the bit cannot have a valid copy of the cache line. A cache line in a Shared state at the Snoop Filter is ambiguous and reflects that the cache line at the node indicated by the presence vector may be either in a Shared or an Invalid state. And finally, if a cache line is in an ambiguous Exclusive state at the Snoop Filter, the cache line at the node indicated by the presence vector may be in any of the supported MESI states, specifically Modified, Exclusive, Shared, or Invalid.

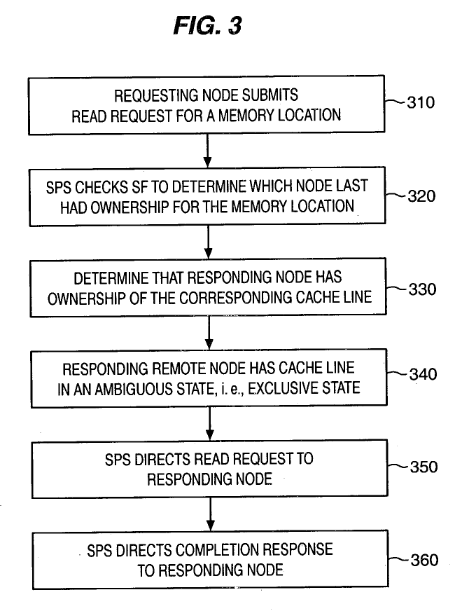

FIG. 3 illustrates what happens in the example illustrated in FIG. 2 where an ambiguity exists in the Snoop Filter. In this example, the requesting node 280 makes a read request for the most current updated contents of memory location 210. The home node 220 is the node where the data is stored for memory AAAA and the responding node 240 is the node that currently has a modified copy of the data for memory location AAAA 230. When the responding node 240 originally acquired its copy of the data for memory location AAAA 230, the Snoop Filter 200 indicated that the responding node 240 had a copy by asserting its presence bit vector and additionally indicated that the responding node 240 was taking the copy in an Exclusive State 291. Once the Snoop Filter identifies that the data resides on the responding node, it need not monitor the activity at the responding node until another request is made. Additionally, the responding node may modify the data and does not need to report the modified data until a request is made by another node to access the data. In this case, the responding node modified the data from X to X+A on the cache line and consequently its local cache line state changed to Modified 270.

FIG. 3 demonstrates the sequence of events taken by the Scalability Port Switch to resolve an ambiguity. In step 310, the requesting node 280 submits a read request for the contents associated with memory location AAAA. At step 320, the SPS 290 determines which node last had ownership of the cache line associated with memory location AAAA. The SPS makes this determination by accessing its snoop filter and identifying which node last had exclusive ownership of the AAAA cache line. In Step 330, the SPS identifies that responding node 240 last had ownership. The SPS, in step 340, then looks at the status of the AAAA cache line last reported and determines that it is in an ambiguous state as the last known state was an Exclusive state. Because the Exclusive state is known to be ambiguous, the SPS must snoop the responding node for its current status as it may have changed due to an internal modification to the responding node's copy contained on its cache line.

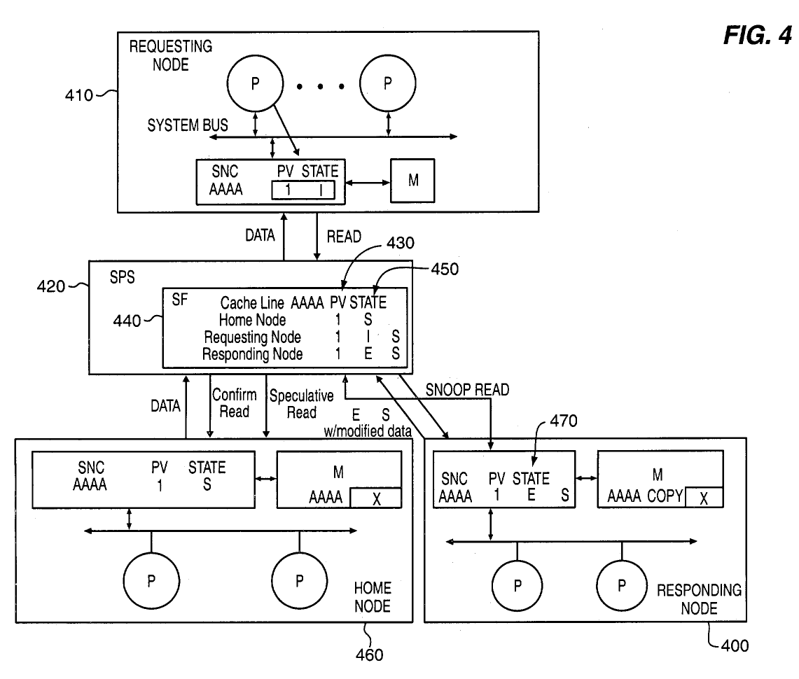

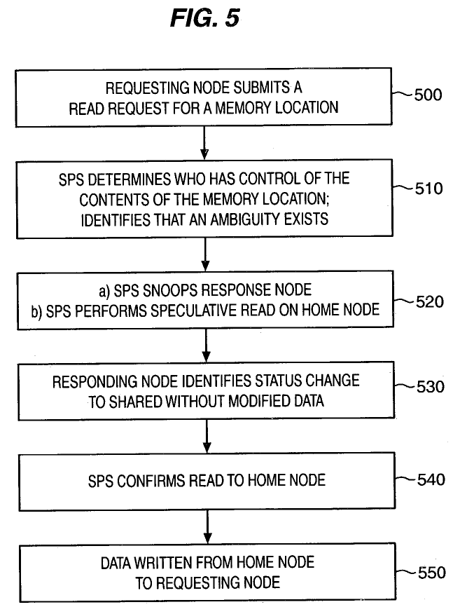

FIGS. 4-5 demonstrate a sequence where the responding node 400 has not modified the contents of the cache line since taking control of the cache line in an Exclusive State. FIG. 4 demonstrates the status of the nodes while FIG. 5 is a flow diagram showing the steps taken in the shared memory environment. At step 500, the requesting node 410 submits a read request for the contents of memory AAAA to the SPS 420. In step 510, the SPS 420 looks at its snoop filter's presence vector 430 and realizes that the responding node last had control of the cache line in question 440 and had access to the line in an ambiguous Exclusive State 450. Because the cache line is in an ambiguous state, the SPS 420 takes two actions substantially simultaneously. At step 520, the SPS 420 a) snoops the responding node 400 to determine if the data has been modified while also simultaneously b) doing a speculative read on the home node 460. In this case, the responding node 400 has not altered the data (still in an exclusive state, not modified 470) and, as a consequence of the snoop by the SPS, the status of the cache line at the responding node changes to a Shared state as the cache line data is being accessed by another node. Consequently, the responding node 400, at step 530 responds to the SPS that the state has changed to a Shared state. At step 540, because the responding node has not modified the data and has issued a state change to Shared without having modified the data, the SPS confirms a memory read to the home node so the best source of the data may be retrieved for the requesting node 410. At step 550, the data is written from the home node through the SPS to the requesting node. In this sample read transaction, when the requesting node has received a copy of the contents, it's status at the Snoop filter changes to a Shared State. The requesting node may then determine that it wants the cache line in an Exclusive state and may submit commands to invalidate or prevent modification of the contents of the cache line at other nodes.

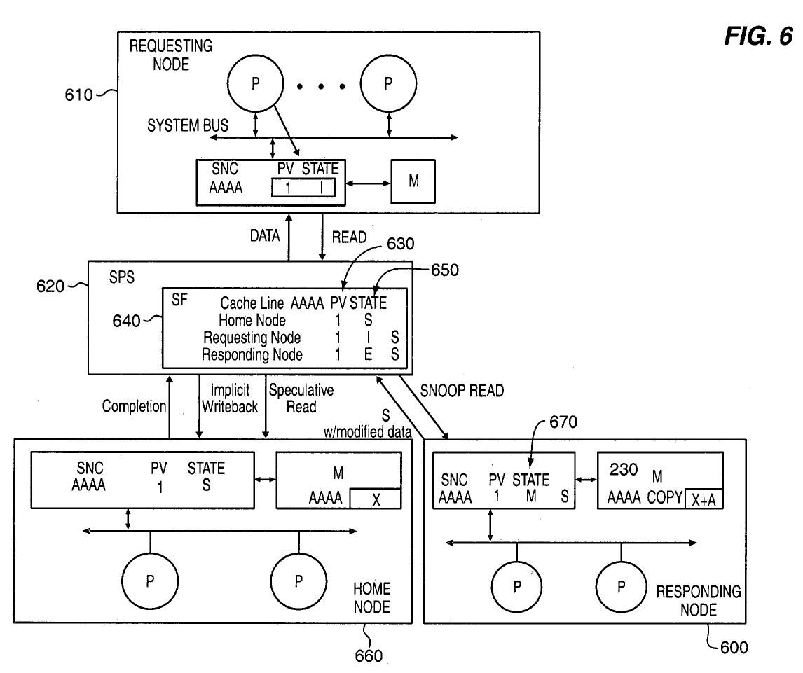

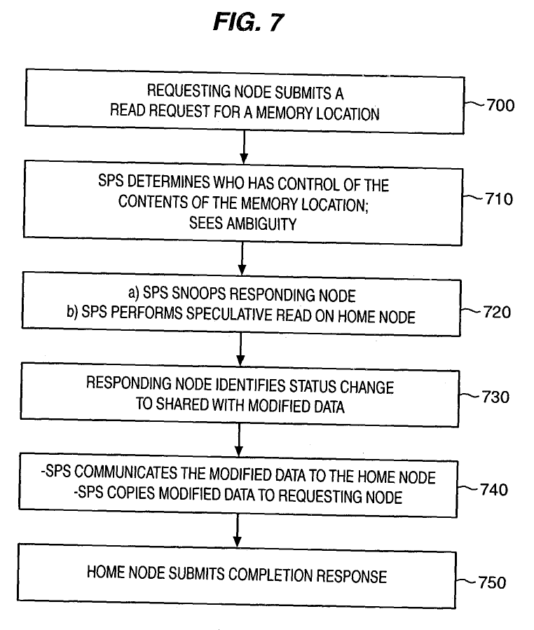

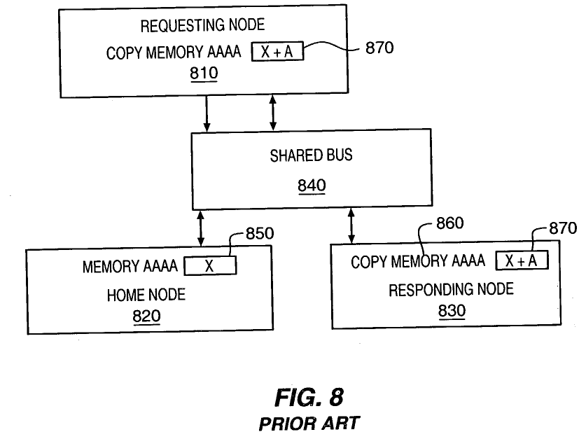

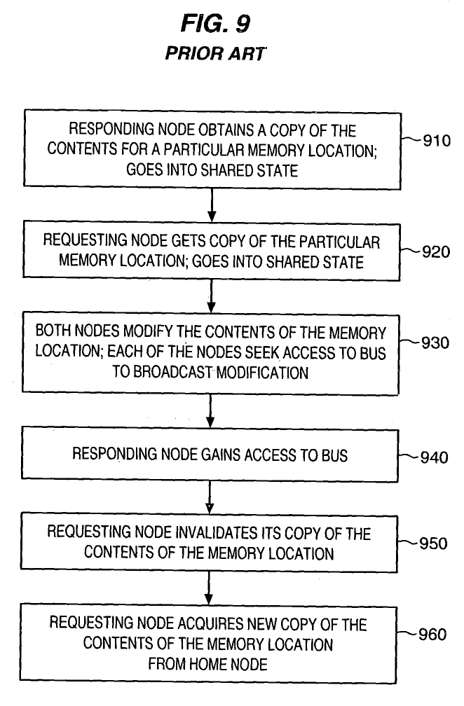

FIGS. 6-7 demonstrate a sequence where the responding node 400 has modified the contents of the cache line since taking control of the cache line in an Exclusive State. FIG. 6 demonstrates the status of the nodes while FIG. 7 is a flow diagram showing the steps taken in the shared memory environment. At step 700, the requesting node 610 submits a read request for the contents of memory AAAA to the SPS 620. In step 710, the SPS 620 looks at its snoop filter's presence vector 630 and realizes that the responding node last had control of the cache line in question 640 and had access to the line in an ambiguous Exclusive State 650. Because the cache line is in an ambiguous state, the SPS 620 takes two actions substantially simultaneously. At step 720, the SPS 620 a) snoops the responding node 600 to determine if the data has been modified while also simultaneously b) doing a speculative read on the home node 660. In this case, the responding node 600 has Modified the data and, as a consequence of the snoop by the SPS, the status of the cache line at the responding node changes from a Modified state to a Shared state as the cache line data is being accessed by another node (in another case, the state may change from Modified to Invalid based on a different type of architecture) Consequently, the responding node 600, at step 730 responds to the SPS that the state is changing to a Shared state and also provides an instruction to the SPS to write the modified data to the Home node, known as an implicit-writeback, while providing a copy of the modified data. At step 740, because the responding node has modified the data and has issued a state change to Shared with instructions concerning the modified the data, the SPS communicates the modified data to the home node while substantially simultaneously copying the data in step 750 to the requesting node node 410 in response to its read request. In this sample read transaction, when the home node has received the updated copy of the contents, it submits in step 750 a completion response to the SPS that directs the completion response to the requesting node. The requesting node may then determine that it wants the cache line in an Exclusive state and may submit commands to invalidate or prevent modification of the contents of the cache line at other nodes.

Alternative Embodiments

The invention has been described above primarily in terms of Intel's Scalability Port architecture. The Snoop Filter mechanism for supporting the full MESI protocol as embodied by the claims is not limited to use in a Distributed Shared Memory environment, nor is it limited to use in conjunction with Intel's Scalability Port. For instance, the claimed invention might be utilized in existing or new Snoop Based architectures.

The foregoing description has discussed the Snoop Filter mechanism as being part of a hardware implemented architecture. It is understood, however, that the invention need not be limited to such a specific application. For example, in certain embodiments the Snoop Filter mechanism could be implemented as programmable code to cooperate the activities of multiple memories located in a distributed fashion. Numerous other embodiments that are limited only by the scope and language of the claims are contemplated as would be obvious to someone possessing ordinary skill in the art and having the benefit of this disclosure.

What is claimed is:

1. A method comprising:
maintaining a state of a cache line indicated by a first node;
in response to a request from a second node to access the cache line, determining whether the state is an ambiguous state; and
resolving the ambiguous state.

2. The method of claim 1 wherein maintaining the state comprises maintaining a presence vector indicating whether the first node has a copy of a contents corresponding to the cache line.

3. The method of claim 2 wherein the presence vector further indicates whether the state is a Shared state or an Exclusive state.

4. The method of claim 1 wherein resolving the ambiguous state comprises snooping the first node for a current status of the cache line.

5. The method of claim 4 further comprising receiving a modified contents of the cache line.

6. The method of claim 5 further comprising updating a memory location designated for storing a contents of the cache line.

7. The method of claim 6 wherein the memory location resides on a third node.

8. The method of claim 1 further comprising completing the request.

9. A method comprising:
maintaining a state of a cache line indicated by a first node of a plurality of nodes in a shared memory system having a copy of a contents stored in a memory location on a second node of the plurality of nodes;
in response to receiving a request from a third node of the plurality of nodes to access the cache line, determining whether the state is an ambiguous state; and
resolving the ambiguous state.

10. The method of claim 9 wherein maintaining the state comprises maintaining a presence vector indicating whether the first node has a copy of a contents corresponding to the cache line.

11. The method of claim 10 wherein the presence vector further indicates whether the state is a Shared state or an Exclusive state.

12. The method of claim 9 wherein resolving the ambiguous state comprises snooping the first node for a current status of the cache line.

13. The method of claim 12 further comprising receiving a modified contents of the cache line.

14. The method of claim 13 further comprising updating the memory location.

15. The method of claim 9 further comprising completing the request.

16. A shared memory multiprocessor system comprising:
a plurality of node controllers and a switch coupled to each of the plurality of node controllers, wherein the plurality of node controllers and the switch are programmed with instructions, the instructions causing the switch to:
maintain a state of a cache line last indicated by a first node controller of the plurality of node controllers; and
in response to a request from a second node to access the cache line, determine whether the state is an ambiguous state; and
resolve the ambiguous state.

17. The shared memory multiprocessor system of claim 16 wherein the switch further comprises a presence vector, the presence vector maintaining a status of a cache line for each corresponding participating node controller of the plurality of node controllers.

18. The shared memory multiprocessor system of claim 17 wherein the presence vector further indicates if the cache line for the corresponding participating node controller contains a copy of a memory.

19. A machine-readable medium having stored thereon data representing sequences of instructions, the sequences of instructions which, when executed by a processor, cause the processor to:
maintain a state of a cache line indicate by a first node;
in response to a request from a second node to access the cache line, determine whether the state is an ambiguous state; and
resolve the ambiguous state.

20. The machine-readable medium of claim 19 wherein the instructions to maintain the state further comprises instructions to maintain a presence vector indicating whether the first node has a copy of a contents corresponding to the cache line.

21. The machine-readable medium of claim 20 wherein the presence vector further indicates whether the state is a Shared state or an Exclusive state.

22. The machine-readable medium of claim 19 wherein the instructions to resolve the ambiguous state further comprises instructions to snoop the first node for a current status of the cache line.

23. The machine-readable medium of claim 22 further comprising instructions to receive a modified contents of the cache line.

24. The machine-readable medium of claim 23 further comprising instructions to update a memory location designated for storing a contents of the cache line.

25. The machine-readable medium of 24 wherein the memory location resides on a third node.

26. The machine-readable medium of 19 further comprising instructions to complete the request.
